(19) United States
(12) Patent Application Publication
(10) Pub. No.: US 2001/0034765 A1
(43) Pub. Date: Oct. 25, 2001

(54) Content management application for an interactive environment

(76) Inventors: Andrea Bimson, Scottsdale, AZ (US); Jin Chyung, Hamburg (DE); Meena Gopakumar, Glendale, AZ (US); Lorraine Miranda, Phoenix, AZ (US); Biswajit Sarkar, Phoenix, AZ (US); Shashikant Rao, Phoenix, AZ (US); Kaustubh Kunte, Phoenix, AZ (US)

Correspondence Address: Howard I. Sobelman, Snell & Wilmer L.L.P., One Arizona Center, 400 E. Van Buren, Phoenix, AZ, 85004-2202, US

(21) Appl. No.: 09/769,924

(22) Filed: Jan. 25, 2001

Related U.S. Application Data
(60) Provisional application No. 60/178,376, filed on Jan. 27, 2000.

(51) Int. Cl. G06F 15/16

(52) U.S. Cl. 709/205; 709/219

(57) ABSTRACT

The content management application is an intranet application which provides a process for implementing changes to an internet website of a company by providing the company the ability to define and enforce a common style of page layout. The application can be accessed via a desktop browser and multiple users may access the application for multiple reasons at the same time. The application also dynamically generates new page designs and new component design with various people assigned to groups or teams enabling the continuous creation and processing of content. Once the content is created and reviewed, it is then launched onto the company's internet site for viewing by the internet users accessing the company's web page.

### CROSS REFERENCE TO RELATED APPLICATIONS

This application claims the benefit of U.S. Provisional Application No. 0/178,376, filed Jan. 27, 2000, the entire contents of which are incorporated by reference.

### FIELD OF THE INVENTION

The invention relates generally to methods and apparatus for implementing changes to an internet website, and more particularly, to systems for defining and enforcing a common style of website page layout for use on Internets and intranets.

### BACKGROUND OF THE INVENTION

As more and more companies begin to provide a presence on the internet, they are confronted with the issues of presentation and conformity within the preparation of the presentations. Various schemes have been presented to assist the companies in preparing the presentation screens that would appear on the internet website. Such approaches have included delegated authority systems, used content aggregation, provided graphical interfaces, and dynamically generated web documents. Further, general website management has included editing and generating information, data access/processing systems, automatic publishing systems and group ware systems. These approaches generally require a knowledge of the HTML authoring language, a capability generally understood by website programmers and not among general employees.

The prior art generally fails to disclose a process for implementing changes to an internet website such that employees in a corporation may define and enforce a common style of page layout. Further, it is desirable to provide an application that can be accessed by multiple users at the same time via an intranet browser, where the application allows corporate employees to manage content, create new web pages, process content through workflow, and define new content and style without requiring that the employee be proficient in the HTML authoring language. It is further desirable that prior to a web page being introduced to the internet, a launch status be assigned to the page such that all appropriate employees, which form the workflow committee, review the content and proposed web page and authorize the launch to the internet. Additionally, it is desired that an access control system that can limit access to certain members within the workflow group and certain areas of the proposed web page be provided.

### SUMMARY OF THE INVENTION

The present invention provides a content management application which is an intranet application for implementing changes to an internet website. The application provides a corporation the ability to define and enforce a common style of page layout in an intranet environment prior to introduction of the page layout to the internet website. The intranet application can be accessed utilizing a standard desktop browser and multiple users may access the application for multiple reasons at the same time. Thus, without the requirement of corporate employees knowing the HTML programming language, they may access the application to manage content, create new pages, process content through workflow, define new content style and/or the like. The content management application also dynamically generates new page designs and new component design, the content of which within the internet can be assigned to groups or teams which enables the creation/processing of content by any member of the team.

The content management application through the use of a workflow concept indicates the status of the user such as, for example, an author, an editor, a legal reviewer, market reviewer, owner and/or the like. In the workflow, after the author drafts content for a proposed web page, the author can transmit the content via the intranet to the next member within the workflow, such as an editor. After all of the appropriate employees within the workflow review the content and proposed web page, the proposed page is assigned a launch status which allows the newly created web page to be made available on the corporation's internet site. The content management application system includes access control such that only certain members within the workflow can access certain documents at certain times. Additionally, the access control can limit access of not only certain members, but also limit access to certain areas of the proposed web page. Thus, templates can be pre-established using a uniform style guide such that when a template is added to the web page, all the templates conform to a uniform style.

### BRIEF DESCRIPTION OF THE DRAWINGS

The above and other features and advantages of the present invention are hereinafter described in the following detailed description of exemplary embodiments to be read in conjunction with the accompanying drawing figures, wherein like reference numerals are used to identify the same or similar parts or steps in the similar views, and:

FIG. 1 is an exemplary pictorial representation of the Content Management Application of the present invention;

FIG. 2 is an exemplary flow diagram of the workflow process of the present invention;

FIG. 3 is an exemplary pictorial representation of the workflow aspect of the present invention;

FIG. 4 is an exemplary block diagram depicting the Administrative User embodiment of the Content Management Utility of the present invention;

FIG. 5 is an exemplary block diagram depicting the Non-Administrative User/Workflow embodiment of the Content Management Utility of the present invention;

FIG. 6 is an exemplary workflow diagram for Content Management Application Administrative users;

FIG. 7 is an exemplary workflow diagram for Content Management Application Non-Administrative users; and

FIGS. 8a-8c are typical examples of screen layout templates for use in enforcing standard page layouts.

### DETAILED DESCRIPTION OF EXEMPLARY EMBODIMENTS

The present invention may be described herein in terms of functional block components and various processing steps. It should be appreciated that such functional blocks may be realized by any number of hardware and/or software components configured to perform the specified functions. For example, the present invention may employ various integrated circuit (IC) components, e.g., memory elements, processing elements, logic elements, look-up tables, and the like, which may carry out a variety of functions under the control of one or more microprocessors or other control devices. Similarly, the software elements of the present invention may be implemented with any programming or scripting language such as C, C++, Java, COBOL, assembler, PERL, or the like, with the various algorithms being implemented with any combination of data structures, objects, processes, routines or other programming elements. For purposes of simplicity and only by way of example and not by way of limitation, the exemplary embodiments are described as using extensible Markup Language (XML). Further, it should be noted that the present invention may employ any number of conventional techniques for data transmission, signaling, data processing, network control, and the like. Still further, the invention could be used to detect or prevent security issues with a scripting language, such as JavaScript, VBScript or the like.

It should be appreciated that the particular implementations shown and described herein are illustrative of the invention and its best mode and are not intended to otherwise limit the scope of the present invention in any way. Indeed, for the sake of brevity, conventional data networking, application development and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical electronic transaction system.

It will be appreciated, that many applications of the present invention could be formulated. One skilled in the art will appreciate that the network may include any system for exchanging data or transacting business, such as the Internet, an intranet, an extranet, WAN, AN, satellite communications, and/or the like. The users may interact with the system via any input device such as a keyboard, mouse, kiosk, persona digital assistant, handheld computer (e.g., Palm Pilot®), cellular phone and/or the like. Similarly, the invention could be used in conjunction with any type of personal computer, network computer, workstation, minicomputer, mainframe, or the like running any operating system such as any version of Windows, Windows NT, Windows2000, Windows 98, Windows 95, MacOS, OS/2, BeOS, Linux, UNIX, or the like. Moreover, although the invention is frequently described herein as being implemented with TCP/IP communications protocols, it will be readily understood that the invention could also be implemented using IPX, Appletalk, IP-6, NetBIOS, OSI or any number of existing or future protocols. Moreover, the system contemplates the use, sale or distribution of any goods, services or information over any network having similar functionality described herein. One skilled in the art will also appreciate that, for security reasons, any databases, systems, or components of the present invention may consist of any combination of databases or components at a single location or at multiple locations, wherein each databases or system includes any of various suitable security features, such as firewalls, access codes, encryption, de-encryption, compression, decompression, and/or the like.

To simplify the description of the exemplary embodiment, the invention is described as pertaining to an internet and intranet system.

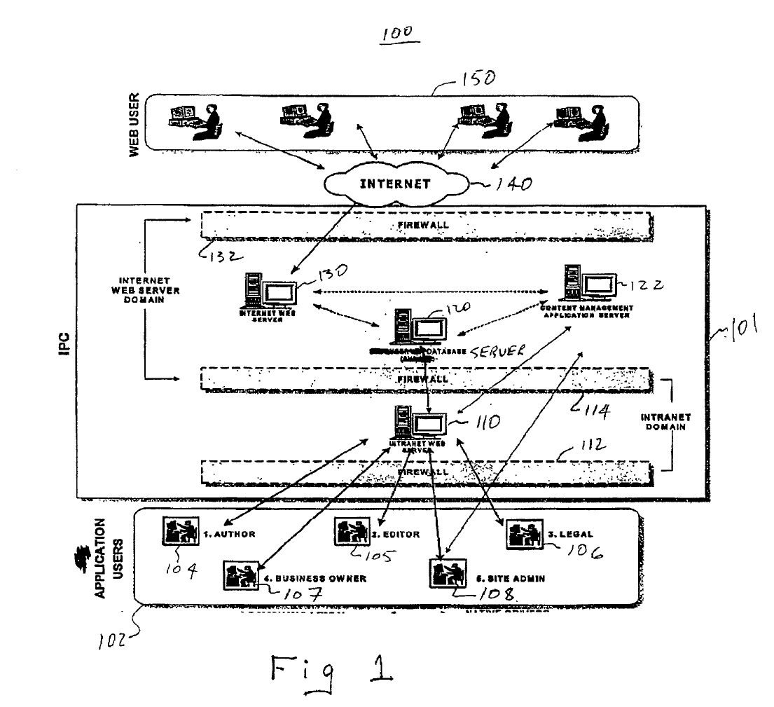

Referring now to FIG. 1, a pictorial representation of the content management application system 100 for use in an active environment is shown. Again, the content management application is directed to a system for permitting a company to implement changes to an internet website by defining and enforcing a common style of age layout produced on an intranet server. The system provides access to various application users 102, including an author 104, an editor 105, legal 106, the business owner 107, and/or the site administrator 108. It is to be understood that reference to the author 104, editor 105, legal 106, business owner 107, and site administrator 108 may be to an entity, group or team as well as to an individual as these titles are related to the function performed, rather than to an individual entity.

Each user is connected through a fir wall 112 to an intranet web server 110 which maintains the page layout for the internet web page on internet web server 130. Intranet web server 110 is coupled through a firewall 114 into a data base server 120. Data bas server 120 is additionally coupled to a content management application serve 122 and an internet web server 130. Site administrator 108 is also connected through firewalls 112, 114 to the content management application server 122 which permits the site administrator to signal the data base serve 120, controlling release of an updated content web page to the internet web server 130. Web users 150 using a standard desktop browser can log onto the internet 140 and, after passing through a firewall 132, enter the secure internet web server to receive the current version of the updated web page.

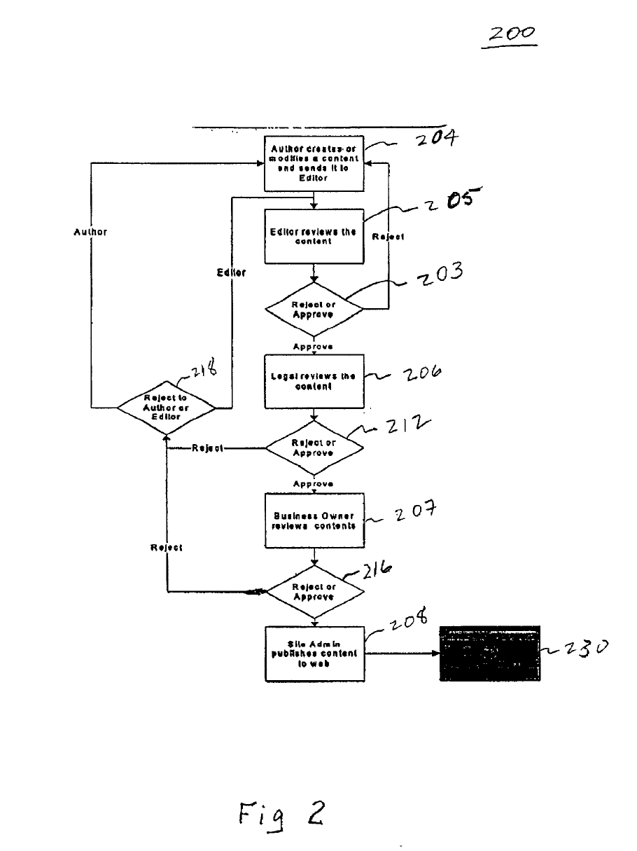

Referring also to FIG. 2, the figure shows a flow diagram 200 of the workflow process of the content management application associated with the application users 102 of FIG. 1. Once a project is initiated by the site administrator to create a new page or to change existing page content to be presented on a web page, an author is assigned to create or modify the content in step 204 and forwards the updated content to an editor for review and editing. The author may be tasked to create new content pertaining only to a portion of a new or an existing page rather than authoring an entire page. In step 205, the editor reviews the content and may either reject the content, returning it to the author for review and/or modification, or approve the content and send it to legal for review in step 206. In step 212, legal may reject or approve the page content received from the editor. If the page content is rejected, legal may return it to either the author or the editor as shown in step 218. If returned to the author, the author reviews the rejection, modifies the content and again sends it to the editor, starting the process over. If sent to the editor, the editor reviews the content with regard to the comments provided by legal and may address legal's concerns or send the page back to the author for review and revision, again restarting the workflow process. If legal approves the content, the page content is then sent to the business owner to review the contents at step 207. As with legal, in step 216, the business owner may reject the content and return it to either the author or the editor for further processing as shown in step 218. If, however, the business owner approves the content, it is sent to the site administrator for publication of the content to the web 230 as above described for FIG. 1.

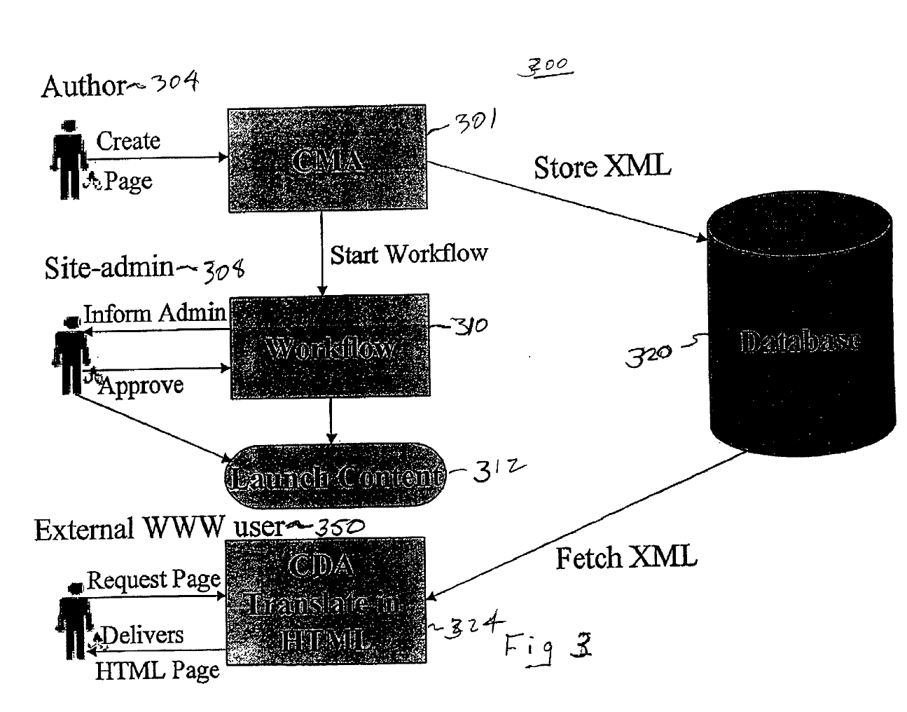

Referring now to FIG. 3, there is shown at 300 a pictorial representation of the flow diagram of FIG. 2. The creation process in the content management application 301 is initiated by an author 304 creating a page. This starts the workflow 310 as above described in FIG. 2. While various scripting languages may be used in creating content and/or a page, by way of example only and not by way of limitation, the content/page is written in XML and stored in a data base 320. Once the workflow process is completed and the site administrator has authorization, the content is launched 312. Upon the site administrator's launching, the updated page content at 301 is stored as an XML (eXtensible Markup Language) file in a data base 320. At this point, an external web user 350 may request the updated page wherein the page is retrieve from the data base in XML format, processed through a CDA translation into an HTML (HyperText Markup Language) format and delivered an HTML page to the user 350.

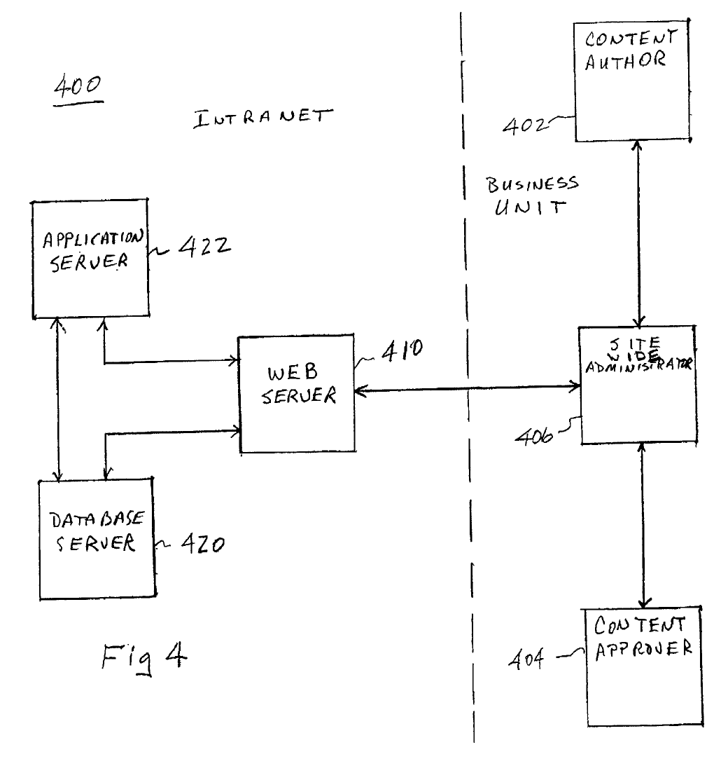

Referring now to FIG. 4, there is shown an exemplary embodiment of the content management application of he present invention at 400 directed to administrative user workflow. In this embodiment, the content management application is under the control of a site wide administrator 406. Site wide administrator 406 sets up a new account using an internet browser application to connect to the production environment. The site wide administrator 406 creates workflow groups that will use the system. Users are then added to the groups and the groups are associated with the project.

As a security precaution, the administrator verbally communicates the user ID and password to each new user. The new user must be previously designated as either a content author 40 or a content approver 404, which would include editor 105, legal 106, business owner, or local site administrator 108. Content authors can then create an edit content items and content approvers have the authority to approve production content as ready to be launched to the website. In this embodiment, no user of the content management application can be associated with more than one entity in the same workflow. That is, the author cannot become an approver of his own work product. Once the new page content has been approved, it is funneled to the site wide administrator 406 for distribution. Site wide administrator 406 sends the approved content to intranet web server 410, which then distributes the upgraded web page to the application server 422 and the data base server 420 for presentation to the internet website of the company.

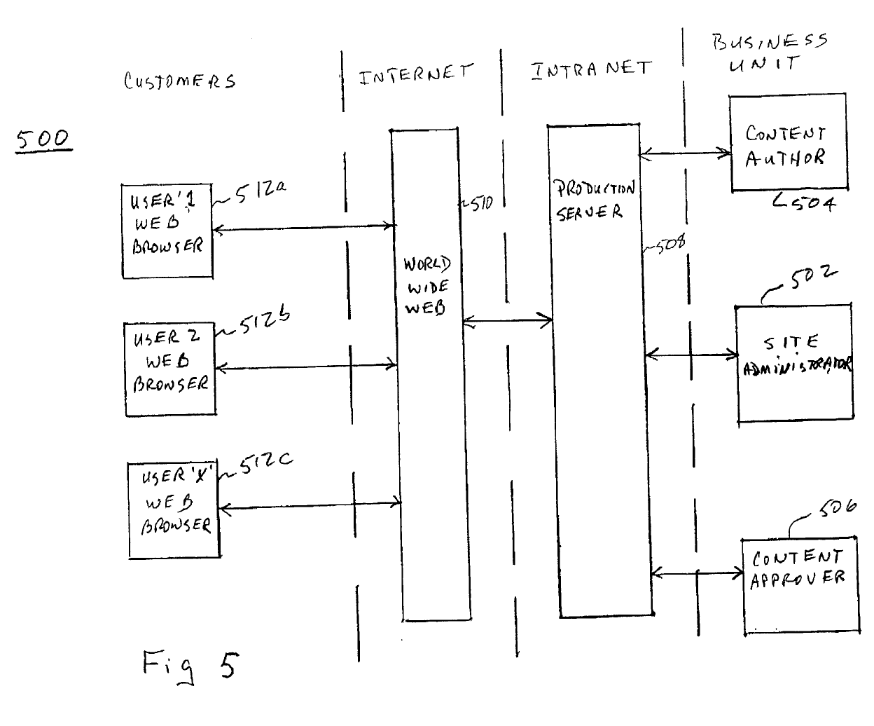

Referring now to FIG. 5, an alternate exemplary embodiment of the content management application is shown at 500. This embodiment is directed to the non-administrative user workflow group under control of the local site administrator 502. Once the site administrator 502 initiates a project and verbally communicates the user ID and password to each new user designated in the workflow, designated content authors 504 can log directly onto a production server 508 and create and edit items using content entry templates accessed via a web browser. Additionally, designated content approvers 506, such as have been previously described, may log directly onto the production server 508 in the intranet and preview content items using a web browser. Content approvers then mark items as approved or rejected as previously discussed in FIG. 2, using the intranet based application. When the new content has been approved by all concerned users in the workflow, the local site administrator will then launch the content. Content is launched by the production server 508 to the worldwide web 510 on the intranet. At this point, users 512a, 512b, and 512c may access the newly added content pages.

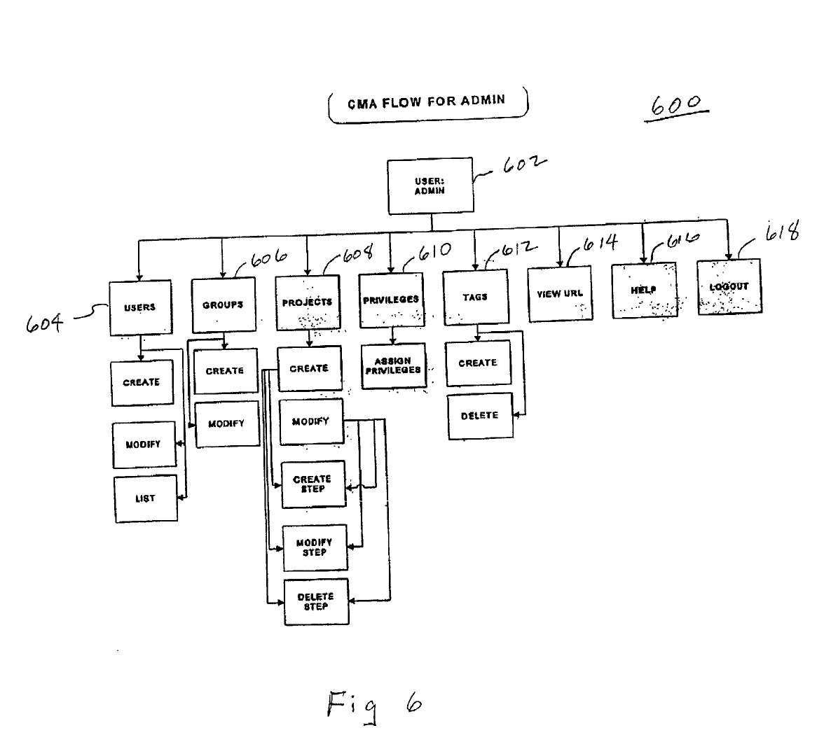

Referring now to FIG. 6, the content management application flow for use by the site wide administrative user disclosed in FIG. 4 is shown at 600. The site wide administrative user 602 can setup workflow users 604 by creating, modifying or listing them. Next, the administrative user 602 may identify groups, creating and modifying workflow groups to include the members of the workflow users. The site wide administrative user 602 sets out projects 608 for the group 606 to address. As certain members of the group 606 may have access only to certain portions of a project 608, the site wide administrative user assigns privileges 610 to the users 604 of a group 606. Further, the site wide administrative user can create or delete tags identified with the project, view the URL where the modified content will reside, request help 616 or log out from the system 618.

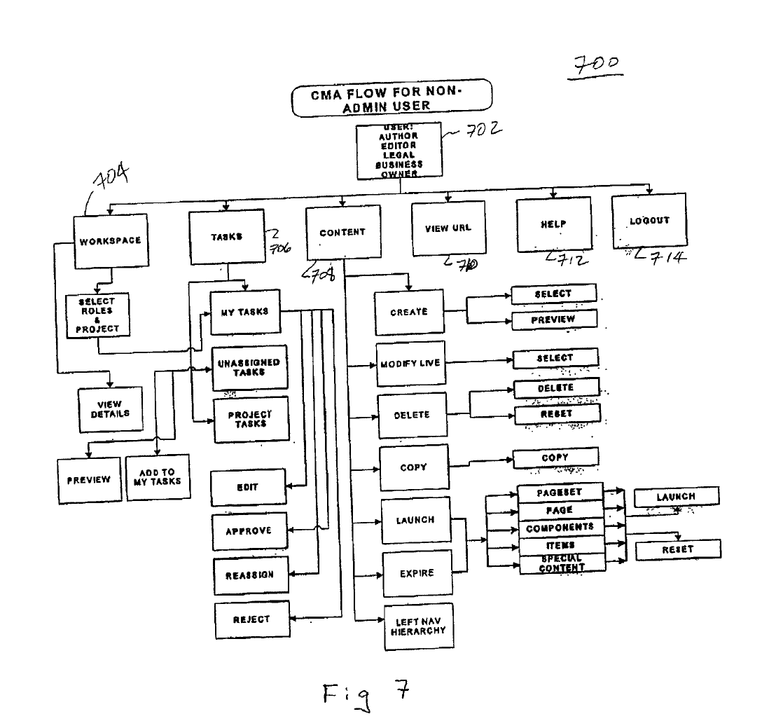

Referring now to FIG. 7, the content management application for non-administrative users is shown at 700. In this embodiment, the user 702 can be the author, editor, legal, business owner, or site administrator. The site administrator defines a work space on the production server to accommodate the changes and modifications to a new content page. The site administrator also sets tasks 706 such that when he selects roles and projects under work space 704, he can then assign the tasks to various entities or groups. As unassigned tasks come up, they may be added to the tasks listed for edit, approval, reassignment, or rejection. An author then defines the content 708 of the page, starting the workflow process through the review by the editor, legal, and the business owner. Again, once the content is approved throughout the workflow, it is sent to the site administrator for launching to the production server on the intranet for introduction to the worldwide web on the internet.

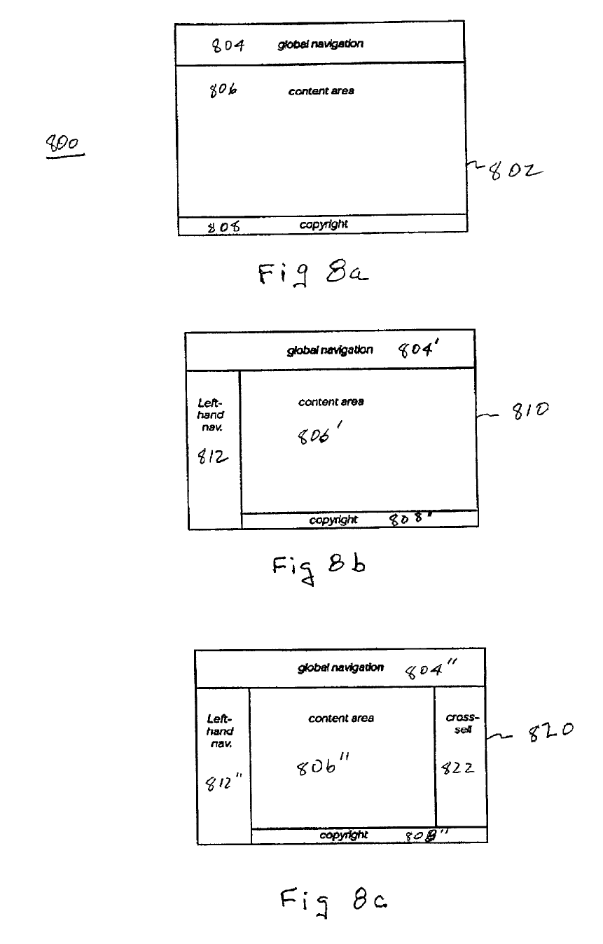

Referring now to FIG. 8a-8c, various templates are depicted at 800 for use in standardizing the content pages which will be created or modified by the workflow process for introduction to the intranet. A number of standard page types have been developed for use with the Content Management Application in order to present a common page style and layout. Page types are general descriptions of the type of information that appears on the page. As a result, templates can be set up in a simple table structure that define the overall structure of the page. The table structure divides the page into areas, each of which is assigned a specific function, such as global navigation, local navigation, content, etc. Thus, by creating templates for use across the company, consistency across the company web site can be ensured. Exemplary embodiments of such templates are depicted in FIGS. 8a-8c.

Referring particularly to FIG. 8a, there is shown a generic template having a global navigation segment 804, a content area 806, and a copyright area 808. This template is used primarily for site wide utility pages which are accessible from the tool bar, such as search or Company information. It is also used for any content which falls outside of the hierarchical navigation of a segment, which will be hereinafter described. This template is generally used for searching a site, the site directory, customer service, information about the company, and as an exception, partner-hosted content.

Referring now to FIG. 8b, there is shown a segment content template 810 again having a global navigation segment 804′, a content area 806′ and a copyright area 808′. In addition, a left hand navigation bar 812 has been added. This navigation bar 812 provides access to various segments located in the content area 806′. This template would be used for demonstrations, demonstration introduction acquisition/registration, interactive and non-interactive content on a fourth level or lower within the web page only site.

Referring now to FIG. 8c, there is depicted a segment content template 810 with a cross-sell column 822. As before, the segment content template with cross-sell column 820 includes a global navigation segment 804″, a content area 806″, a copyright area 808″ and a left hand navigation column 812″. The new cross-sell column 822 is used to present content, such as general information or product descriptions, product/service pages, category introduction pages, output pages and glossaries.

While only three types of templates have been described, it should be understood that other templates for other reasons and other uses can be designed and utilized for presentation of company content to the internet website. As such, these templates are by way of example only and are not by way of limitation to the style and format of templates used to present company information and content. Accordingly, corresponding structures, acts, and equivalents of all elements in the claims below are intended to include any structural material or acts for performing the functions in combination with other elements as specifically claimed. The scope of the invention should be determined by the allowed claims and their legal equivalents, rather than by the examples given above.

What is claimed is:

1. A system for implementing changes to content on an internet website server, comprising:
an intranet server coupled to provide input to said internet server;
a workflow application coupled to said intranet server;
an author interfacing with said workflow application to develop and provide page content in said workflow application;
at least one reviewer interfacing with said workflow application for receiving and reviewing said page content; and
an administrator interfacing with said workflow application for receiving page content reviewed and approved by said at least one reviewer and launching said content to said intranet server for input to said internet server.

2. The system of claim 1, further including at least a second reviewer interfacing with said workflow application.

3. The system of claim 1, wherein said at least one reviewer is an editor.

4. The system of claim 2, wherein said at least a second reviewer is a legal reviewer.

5. The system of claim 2, wherein said at least a second reviewer is a business owner.

6. The system of claim 1, wherein said at least one reviewer rejects said page content and returns said rejected page content to said workflow application for revision by said author, said author revising said page content and returning said revised page content to said workflow application for review.

7. The system of claim 2, wherein said at least a second reviewer rejects said page content and returns said rejected page content to said workflow application for revision.

8. The system of claim 7, wherein said rejected page content returned to said workflow application is sent to said author for revision.

9. The system of claim 7, wherein said rejected page content returned to said workflow application is sent to said at least one reviewer for revision.

10. The system of claim 6, said administrator interfacing with said workflow application for receiving revised page content reviewed and approved by said at least one reviewer and launching said content to said intranet server for input to said internet server.

11. The system of claim 7, said administrator interfacing with said workflow application for receiving revised page content reviewed and approved by said at least a second reviewer and launching said content to said intranet server for input to said internet server.

12. A method for implementing changes to content on an internet website server, comprising the steps of:
coupling an intranet server to provide input to said internet server;
coupling a workflow application to said intranet server;
interfacing an author with said workflow application to develop and provide page content in said workflow application;
interfacing at least one reviewer with said workflow application for receiving and reviewing said page content; and
interfacing an administrator with said workflow application for receiving page content reviewed and approved by said at least one reviewer and launching said content to said intranet server for input to said internet server.

13. The method of claim 12, further including interfacing at least a second reviewer with said workflow application.

14. The method of claim 13, including reviewing and rejecting said page content and returning said rejected page content to said workflow application for revision, revising said page content and returning said revised page content to said workflow application for review.

15. The method of claim 14, including interfacing said administrator with said workflow application for receiving approved revised page content and launching said page content to said intranet server for input to said internet server.
